(19) United States
(12) Patent Application Publication
(10) Pub. No.: US 2026/0352100 A1
(43) Pub. Date: Nov. 5, 2026

(54) POWER CONVERSION CIRCUIT HAVING MULTIPLE HYBRID SWITCHED-CAPACITOR CONVERTERS AND CONTROL METHOD THEREOF

(71) Applicant: Richtek Technology Corporation, Zhubei City (TW)

(72) Inventors: Kuo-Chi Liu, Hsinchu (TW); Chih-Hua Hou, Hsinchu (TW)

(21) Appl. No.: 19/357,559

(22) Filed: Oct. 14, 2025

Related U.S. Application Data
(60) Provisional application No. 63/769,751, filed on Mar. 11, 2025.

(30) Foreign Application Priority Data
Aug. 4, 2025 (TW) 114129572

(51) Int. Cl. H02M 3/07; H02M 1/00; H02M 3/158

(52) U.S. Cl. CPC H02M 3/07; H02M 1/0043; H02M 1/0095; H02M 3/158

(57) ABSTRACT

A power conversion circuit having multiple hybrid switched-capacitor converters is disclosed. The circuit converts an input voltage to first and second output voltages, and includes first and second hybrid switched-capacitor converters and a middle capacitor. The first converter includes a switched-capacitor voltage division circuit having first to fourth switches electrically connected in order between the input voltage and a ground potential, and a first flying capacitor connected between the second and third switches. According to a first PWM signal group, a first inductor is periodically magnetized and demagnetized to generate a first output voltage. The second hybrid switched-capacitor converter includes a second switched-capacitor voltage division circuit and a second inductor, and operates according to a second PWM signal group to generate a second output voltage. The middle capacitor cooperates with the first and second flying capacitors respectively to perform switched-capacitor operations.

### CROSS REFERENCE

The present invention claims priority to provisional application 63/769751 filed on March 11, 2025, and TW 114129572 filed on Aug. 4, 2025.

### BACKGROUND OF THE INVENTION

### Field of Invention

The present invention relates to a power conversion circuit having multiple hybrid switched-capacitor converters and a control method thereof. More particularly, the present invention relates to a power conversion circuit having multiple hybrid switched-capacitor converters with a middle capacitor coupled to the hybrid switched-capacitor converters for cooperating in switched-capacitor operations, and a control method thereof.

### Description of Related Art

Nowadays, data centers, servers, electric vehicles, and various mobile devices often require power converters with multiple output voltages. Under increasingly stringent spatial and thermal constraints, designing power converters with high power density and high efficiency has become a critical research focus. In conventional technologies, as illustrated in FIG. 1, a power conversion circuit 10 with multiple buck converters is employed to provide multiple outputs through different combinations of switches and inductors. In FIG. 1, an input voltage Vin is simultaneously coupled to two buck converter stages. Switches Q1u, Q1l, and inductor L1 form a first buck converter, while switches Q2u, Q2l, and inductor L2 form a second buck converter. These stages respectively generate a first output voltage Vout1 and a second output voltage Vout2. At the input side, capacitors Cin1 and Cin2 are coupled to the inputs of the respective buck converters to filter voltage ripple. At the output side, capacitors Co1 and Co2 are respectively coupled to the outputs of the first and second buck converters to stabilize Vout1 and Vout2.

In the power conversion circuit 10 illustrated in FIG. 1, all switches Q1u, Q1l, Q2u, and Q2l must be able to withstand a maximum value of the input voltage Vin to ensure stable operation. Since the input voltage Vin may be relatively high, this imposes stringent voltage requirements on the switches, which in turn leads to higher on-resistance and greater conduction losses. Furthermore, to enable effective power conversion under high input voltage conditions, conventional buck converters must use larger inductors L1 and L2 to accommodate the voltage difference between Vin and the output voltages Vout1 and Vout2, resulting in increased volume and cost for the magnetic components. This makes it difficult to reduce the overall size of the power system or improve its power density.

As each output in the power conversion circuit 10 requires a dedicated buck converter and inductor, this increases the complexity of system layout and heat dissipation. In environments with high temperatures or limited thermal dissipation capabilities, ensuring reliable long-term operation often necessitates additional thermal design measures or the use of higher-grade components, thereby increasing the cost and design complexity.

In applications requiring multiple output voltages, the traditional approach of deploying several independent power converters leads to a significant increase in component count and wiring complexity. For systems that must simultaneously support various voltage rails—such as USB ports, core voltages for processors, and power for peripheral components—this architecture becomes difficult to integrate into a single monolithic chip or power module.

### SUMMARY OF THE INVENTION

From one perspective, the present invention provides a power conversion circuit having multiple hybrid switched-capacitor converters, configured to convert an input voltage to a first output voltage at a first output terminal and a second output voltage at a second output terminal, comprising: a first hybrid switched-capacitor converter comprising a first switched-capacitor voltage divider circuit and a first inductor electrically coupled to each other, wherein the first switched-capacitor voltage divider circuit comprises: a first switch, a second switch, a third switch, and a fourth switch, electrically connected in order from the input voltage to a ground potential; and a first flying capacitor, having an end electrically connected to a node between the first switch and the second switch, and another end electrically connected to a node between the third switch and the fourth switch; wherein the first switched-capacitor voltage divider circuit is configured to perform a first switched-capacitor operation by controlling the first switch, the second switch, the third switch, and the fourth switch according to a first pulse-width modulation (PWM) signal group, such that the input voltage is converted to two voltage levels of a first voltage division group; wherein a switching end of the first inductor is configured to switch between the two voltage levels of the first voltage division group according to the first PWM signal group, such that the first inductor is periodically magnetized and demagnetized to convert the input voltage to the first output voltage; a second hybrid switched-capacitor converter comprising a second switched-capacitor voltage divider circuit and a second inductor electrically coupled to each other, wherein the second switched-capacitor voltage divider circuit comprises: a fifth switch, a sixth switch, a seventh switch, and an eighth switch, electrically connected in order from the input voltage to the ground potential; and a second flying capacitor, having an end electrically connected to a node between the fifth switch and the sixth switch, and another end electrically connected to a node between the seventh switch and the eighth switch; wherein the second switched-capacitor voltage divider circuit is configured to perform a second switched-capacitor operation by controlling the fifth switch, the sixth switch, the seventh switch, and the eighth switch according to a second PWM signal group, such that the input voltage is converted into two voltage levels of a second voltage division group; wherein a switching end of the second inductor is configured to switch between the two voltage levels of the second voltage division group according to the second PWM signal group, such that the second inductor is periodically magnetized and demagnetized to convert the input voltage to the second output voltage; and a middle capacitor having a first terminal and a second terminal, wherein the first terminal is electrically connected to a node between the second switch and the third switch and also electrically connected to a node between the sixth switch and the seventh switch, and the second terminal is electrically connected to the ground potential, wherein the middle capacitor is configured to cooperate with the first flying capacitor to perform the first switched-capacitor operation, and also to cooperate with the second flying capacitor to perform the second switched-capacitor operation.

From another perspective, the present invention provides a control method of a power conversion circuit having multiple hybrid switched-capacitor converters, wherein the power conversion circuit comprises a first hybrid switched-capacitor converter, a second hybrid switched-capacitor converter, and a middle capacitor electrically coupled to each other, the control method comprising: controlling multiple switches of the first hybrid switched-capacitor converter according to a first PWM signal group to perform a first switched-capacitor operation and convert an input voltage into two voltage levels of a first voltage division group; periodically switching a first inductor of the first hybrid switched-capacitor converter between the two voltage levels of the first voltage division group to perform magnetizing and demagnetizing operations, thereby converting the input voltage to a first output voltage at a first output terminal; controlling multiple switches of the second hybrid switched-capacitor converter according to a second PWM signal group to perform a second switched-capacitor operation and convert the input voltage into two voltage levels of a second voltage division group; periodically switching a second inductor of the second hybrid switched-capacitor converter between the two voltage levels of the second voltage division group to perform magnetizing and demagnetizing operations, thereby converting the input voltage to a second output voltage at a second output terminal; and operating the middle capacitor to cooperate with a first flying capacitor of the first hybrid switched-capacitor converter to perform the first switched-capacitor operation, and to cooperate with a second flying capacitor of the second hybrid switched-capacitor converter to perform the second switched-capacitor operation.

In one embodiment, the switching end of the first inductor is selectively electrically connected to a node between the first switch and the second switch, or to a node between the third switch and the fourth switch, and an output end of the first inductor is electrically coupled to the first output terminal; wherein the switching end of the second inductor is selectively electrically connected to a node between the fifth switch and the sixth switch, or to a node between the seventh switch and the eighth switch, and an output end of the second inductor is electrically connected to the second output terminal.

In one embodiment, the first switch and the fifth switch are interleaved with a phase shift, the phase shift being 90 degrees, 180 degrees, or 270 degrees.

In one embodiment, a frequency of the first PWM signal group is identical to a frequency of the second PWM signal group.

In one embodiment, each of a voltage across the middle capacitor, a voltage across the first flying capacitor, and a voltage across the second flying capacitor has a DC bias of one-half or less of the input voltage.

In one embodiment, when the first output voltage or the second output voltage is set higher than one-fourth of the input voltage, or in response to transient load variation, duty ratios of the first PWM signal group and the second PWM signal group are greater than 50%.

In one embodiment, the first output terminal and the second output terminal are electrically connected as a common output terminal to provide a shared output voltage.

In one embodiment, the first inductor and the second inductor are magnetically coupled through a magnetic material.

In one embodiment, the power conversion circuit having multiple hybrid switched-capacitor converters further comprises a pre-regulator configured as a divided-by-two switched-capacitor converter and coupled between the input voltage and the first and fifth switches, for converting the input voltage to one-half of the input voltage.

In one embodiment, the pre-regulator comprises an auxiliary flying capacitor, a first auxiliary switch, and a second auxiliary switch coupled between the input voltage, the first switch, and the fifth switch to perform a switched-capacitor operation.

In one embodiment, the two voltage levels of the first voltage division group are two different levels among the input voltage, one-half of the input voltage, and a ground potential; and the two voltage levels of the second voltage division group are two different levels among the input voltage, one-half of the input voltage, and the ground potential.

In one embodiment, the first PWM signal group comprises two signals having a phase difference of 180 degrees, the second PWM signal group also comprises two signals having a phase difference of 180 degrees, and the first PWM signal group and the second PWM signal group are interleaved with a phase shift of 90 degrees, 180 degrees, or 270 degrees.

In one embodiment, when the first output voltage or the second output voltage is set higher than one-fourth of the input voltage, or in response to transient load variation, a duty ratio of the first PWM signal group or the second PWM signal group is greater than 50%.

In one embodiment, the control method of the power conversion circuit having multiple hybrid switched-capacitor converters further comprises: converting the input voltage into one-half of the input voltage, and then converting the half input voltage into two voltage levels of the first voltage division group and two voltage levels of the second voltage division group.

The power conversion circuit having multiple hybrid switched-capacitor converters of the present invention provides several specific advantages over the conventional buck converter architecture shown in FIG. 1.

First, in the present invention, both voltage and current are cleverly distributed among multiple components, thereby improving power conversion efficiency. Since each inductor is subjected to only a lower voltage difference (approximately equal to one-half of the input voltage minus the output voltage), both the required inductance and the physical size of the inductor can be significantly reduced, resulting in lower DC resistance and power loss. This design also enables a higher voltage conversion ratio between the input and output voltages, which is particularly suitable for applications such as converting a 48-volt bus to low output voltages.

Furthermore, the present invention divides the input power through the configuration of flying capacitors and a shared middle capacitor, so that the voltage stress of each switching device (such as Q1-Q8) is limited to approximately one-half of the input voltage (Vin/2). As a result, switching devices with lower voltage ratings and smaller on-resistances can be adopted to reduce switching losses. In addition, each switching device carries approximately one-half of the inductor current of a conventional architecture, further reducing conduction losses and thermal dissipation while enhancing overall efficiency.

The middle capacitor of the present invention provides an effective clamping function for the switching node voltages, preventing voltage spikes during switching transitions. Therefore, additional RC snubber circuits are unnecessary for device protection. Moreover, by employing multi-phase interleaved switching operation, the input current ripple is greatly reduced, which not only lessens the requirement for input filter capacitors but also improves overall system efficiency and stability.

The objectives, technical details, features, and effects of the present invention will be better understood with regard to the detailed description of the embodiments below, with reference to the attached drawings.

### BRIEF DESCRIPTION OF THE DRAWINGS

FIG. 1 is a schematic diagram illustrating a conventional power conversion circuit having multiple buck converters.

FIG. 2 is a schematic diagram illustrating a power conversion circuit having multiple hybrid switched-capacitor converters according to an embodiment of the present invention.

FIG. 3 is a schematic diagram illustrating a power conversion circuit having multiple hybrid switched-capacitor converters according to another embodiment of the present invention.

FIG. 4 is a schematic diagram illustrating a power conversion circuit having multiple hybrid switched-capacitor converters according to still another embodiment of the present invention.

FIG. 5 is a schematic diagram illustrating a power conversion circuit having multiple hybrid switched-capacitor converters according to yet another embodiment of the present invention.

FIG. 6 is a schematic diagram illustrating a power conversion circuit having multiple hybrid switched-capacitor converters according to another embodiment of the present invention.

FIG. 7 is a schematic diagram illustrating a power conversion circuit having multiple hybrid switched-capacitor converters according to an embodiment of the present invention.

FIG. 8A-8D are schematic diagrams illustrating different switching states according to an embodiment of the present invention.

FIG. 9 is a schematic diagram illustrating a power conversion circuit having multiple hybrid switched-capacitor converters according to an embodiment of the present invention.

FIG. 10 is a schematic diagram illustrating a power conversion circuit having multiple hybrid switched-capacitor converters according to an embodiment of the present invention.

FIG. 11 is a circuit schematic diagram illustrating a current sensing circuit of a control signal generation circuit according to an embodiment of the present invention.

FIG. 12 is a signal waveform diagram illustrating related signals of a power conversion circuit having multiple hybrid switched-capacitor converters according to an embodiment of the present invention.

FIG. 13 is a signal waveform diagram illustrating related signals of a power conversion circuit having multiple hybrid switched-capacitor converters according to another embodiment of the present invention.

FIG. 14 is a signal waveform diagram illustrating related signals of a power conversion circuit having multiple hybrid switched-capacitor converters according to an embodiment of the present invention.

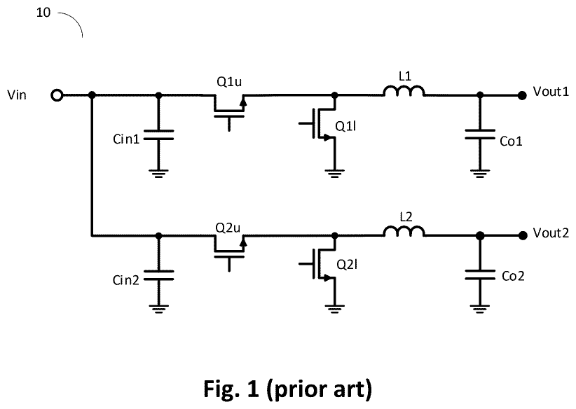

### DESCRIPTION OF THE PREFERRED EMBODIMENTS

The drawings as referred to throughout the description of the present invention are for illustration only, to show the interrelations between the circuits and the signal waveforms, but not drawn according to actual scale of circuit sizes and signal amplitudes and frequencies.

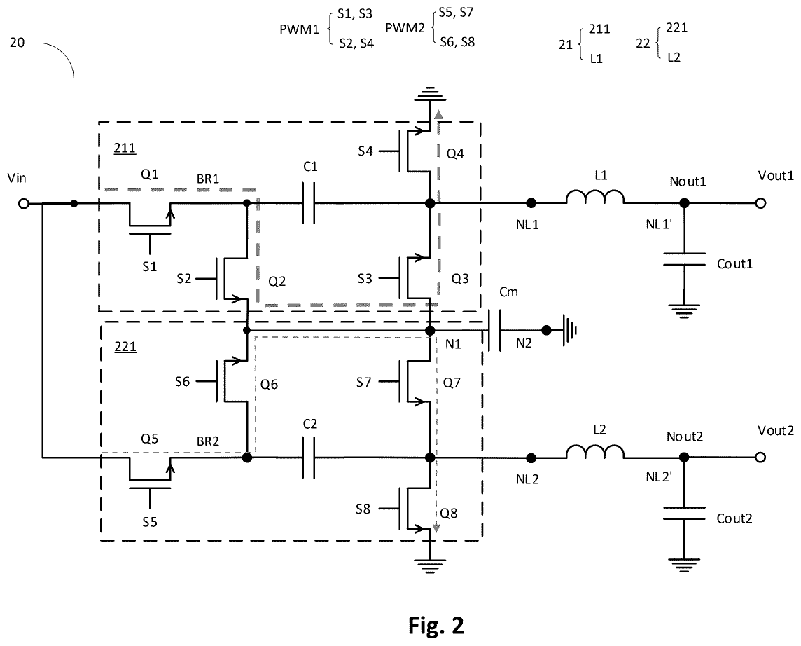

FIG. 2 is a schematic diagram illustrating a power conversion circuit having multiple hybrid switched-capacitor converters according to an embodiment of the present invention. As shown in FIG. 2, a power conversion circuit 20 having multiple hybrid switched-capacitor converters is configured to convert an input voltage Vin to a first output voltage Vout1 at a first output terminal Nout1 and a second output voltage Vout2 at a second output terminal Nout2. The power conversion circuit 20 includes a first hybrid switched-capacitor converter 21, a second hybrid switched-capacitor converter 22, and a middle capacitor Cm.

The first hybrid switched-capacitor converter 21 includes a first switched-capacitor voltage divider circuit 211 and a first inductor L1 electrically coupled to each other. The first switched-capacitor voltage divider circuit 211 includes a first switch Q1, a second switch Q2, a third switch Q3, a fourth switch Q4, and a first flying capacitor C1. The first switch Q1, the second switch Q2, the third switch Q3, and the fourth switch Q4 are electrically connected in order between the input voltage Vin and a ground potential. As illustrated in FIG. 2, the switches Q1-Q4 are sequentially connected to form a first branch BR1 between the input voltage Vin and the ground potential, as indicated by a bold dashed line with arrows. One end of the first flying capacitor C1 is electrically connected to a node between the first switch Q1 and the second switch Q2, and the other end is electrically connected to a node between the third switch Q3 and the fourth switch Q4, such that the first flying capacitor C1 is connected in parallel with the series-connected second and third switches Q2, Q3. The first switched-capacitor voltage divider circuit 211 is configured to perform a switched-capacitor operation according to a first pulse-width modulation (PWM) signal group PWM1 by controlling the first to fourth switches Q1-Q4 to convert the input voltage Vin into two voltage levels of a first voltage division group. The first PWM signal group PWM1 includes switching control signals S1, S2, S3, and S4 respectively controlling Q1, Q2, Q3, and Q4. A switching terminal NL1 of the first inductor L1 is switched between the two voltage levels of the first voltage division group according to the first PWM signal group, such that the first inductor L1 is periodically magnetized and demagnetized to perform power conversion between the input voltage Vin and the first output voltage Vout1.

The second hybrid switched-capacitor converter 22 includes a second switched-capacitor voltage divider circuit 221 and a second inductor L2 electrically coupled to each other. The second switched-capacitor voltage divider circuit 221 includes a fifth switch Q5, a sixth switch Q6, a seventh switch Q7, an eighth switch Q8, and a second flying capacitor C2. The switches Q5-Q8 are electrically connected in order between the input voltage Vin and the ground potential, forming a second branch BR2, as indicated by a thin dashed line with arrows in FIG. 2. One end of the second flying capacitor C2 is electrically connected to a node between the fifth and sixth switches Q5, Q6, and the other end is electrically connected to a node between the seventh and eighth switches Q7, Q8, such that the second flying capacitor C2 is connected in parallel with the series-connected sixth and seventh switches Q6, Q7. The second switched-capacitor voltage divider circuit 221 performs a switched-capacitor operation according to a second PWM signal group PWM2 by controlling the fifth to eighth switches Q5-Q8 to convert the input voltage Vin into two voltage levels of a second voltage division group. The second PWM signal group PWM2 includes switching control signals S5, S6, S7, and S8 respectively controlling Q5, Q6, Q7, and Q8. A switching terminal NL2 of the second inductor L2 is switched between the two voltage levels of the second voltage division group according to the second PWM signal group, such that the second inductor L2 is periodically magnetized and demagnetized to perform power conversion between the input voltage Vin and the second output voltage Vout2. The two voltage levels of the first or second voltage division group may, for example, correspond to Vin and Vin×½, or Vin×½ and 0 (ground potential).

The middle capacitor Cm has a first terminal N1 and a second terminal N2. The first terminal N1 is electrically connected to the node between the second switch Q2 and the third switch Q3 in the first branch BR1, and also connected to the node between the sixth switch Q6 and the seventh switch Q7 in the second branch BR2. The second terminal N2 is connected to the ground potential. The middle capacitor Cm cooperates with the first flying capacitor C1 to perform a first switched-capacitor operation and also cooperates with the second flying capacitor C2 to perform a second switched-capacitor operation. In other words, the middle capacitor Cm is shared by the first hybrid switched-capacitor converter 21 and the second hybrid switched-capacitor converter 22 to jointly perform the switched-capacitor operations with their corresponding flying capacitors.

At the first output terminal Nout1, a first output capacitor

Cout1 is coupled to the output of the first hybrid switched-capacitor converter 21 to stabilize the first output voltage Vout1; and at the second output terminal Nout2, a second output capacitor Cout2 is coupled to the output of the second hybrid switched-capacitor converter 22 to stabilize the second output voltage Vout2.

In this embodiment, the switching terminal NL1 of the first inductor L1 is connected to a node between the third and fourth switches Q3, Q4 of the first branch BR1, and an output terminal NL1′ of the first inductor L1 is connected to the first output voltage Vout1. Similarly, the switching terminal NL2 of the second inductor L2 is connected to a node between the seventh and eighth switches Q7, Q8 of the second branch BR2, and an output terminal NL2′ of the second inductor L2 is connected to the second output voltage Vout2.

The middle capacitor Cm is selectively coupled to the first flying capacitor C1 and the second flying capacitor C2 through the conduction control of the switches Q1-Q8. Accordingly, under different switching states, the middle capacitor Cm forms parallel or series connections with the corresponding flying capacitors to perform the switched-capacitor operations. Each of the first flying capacitor C1, the second flying capacitor C2, and the middle capacitor Cm is biased at a DC voltage of approximately one-half of the input voltage (Vin/2). Furthermore, the middle capacitor Cm provides a voltage clamping function to suppress voltage spikes at the switching nodes, thereby limiting the voltage stress of all switches Q1-Q8 to approximately Vin/2. Since the equivalent voltage across each inductor (L1, L2) is reduced to approximately (Vin/2 Vout), smaller inductors with lower inductance and lower resistance can be employed to reduce losses. Notably, the power conversion circuit 20 having multiple hybrid switched-capacitor converters also supports bidirectional power conversion—it can step down the input voltage Vin to generate Vout1 and Vout2, or conversely, step up Vout1 or Vout2 to generate Vin.

In one embodiment, the first switch Q1 and the fifth switch

Q5 are interleaved with an adjustable phase shift, which may be 90 degrees, 180 degrees, or 270 degrees. It is noted that the first PWM signal group includes two signals with a 180-degree phase difference to control the first to fourth switches Q1-Q4, and the second PWM signal group also includes two signals with a 180-degree phase difference to control the fifth to eighth switches Q5-Q8, as will be described in detail later. The phase difference such as 90 degrees, 180 degrees, or 270 degrees represents nominal values and may include acceptable engineering tolerances.

In one embodiment, the first switch Q1 and the fifth switch Q5 are synchronously switched with the same switching frequency. In other words, the frequency of the first PWM signal group is identical to that of the second PWM signal group.

In one embodiment, the middle capacitor Cm, the first flying capacitor C1, and the second flying capacitor C2 each have a DC bias voltage equal to or lower than one-half of the input voltage Vin.

In one embodiment, when the first output voltage Vout1 or the second output voltage Vout2 is set higher than one-quarter of the input voltage Vin, or during transient load conditions, the corresponding first switch Q1 or fifth switch Q5 operates with a duty cycle greater than 50%. That is, under these conditions, the duty cycle of the PWM signal controlling Q1 or Q5 may exceed 50%.

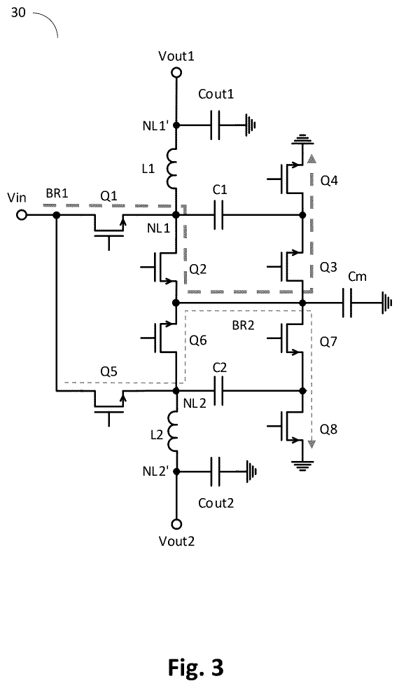

FIG. 3 is a schematic diagram illustrating a power conversion circuit having multiple hybrid switched-capacitor converters according to an embodiment of the present invention. The power conversion circuit 30 differs from the power conversion circuit 20 shown in FIG. 2 in that, in this embodiment, the switching terminal NL1 of the first inductor L1 can be selectively connected to the node between the first switch Q1 and the second switch Q2 of the first branch BR1, while the output terminal NL1′ of the first inductor L1 remains connected to the first output terminal Nout1. Likewise, the switching terminal NL2 of the second inductor L2 can be selectively connected to the node between the fifth switch Q5 and the sixth switch Q6 of the second branch BR2, while the output terminal NL2′ of the second inductor L2 remains connected to the second output voltage Vout2.

In the embodiment of the power conversion circuit 20 shown in FIG. 2, the voltage range of Vout1 and Vout2 falls between one-half of the input voltage Vin and the ground potential. In contrast, in the embodiment of the power conversion circuit 30 shown in FIG. 3, the voltage range of Vout1 and Vout2 falls between one-half of the input voltage Vin and the input voltage Vin.

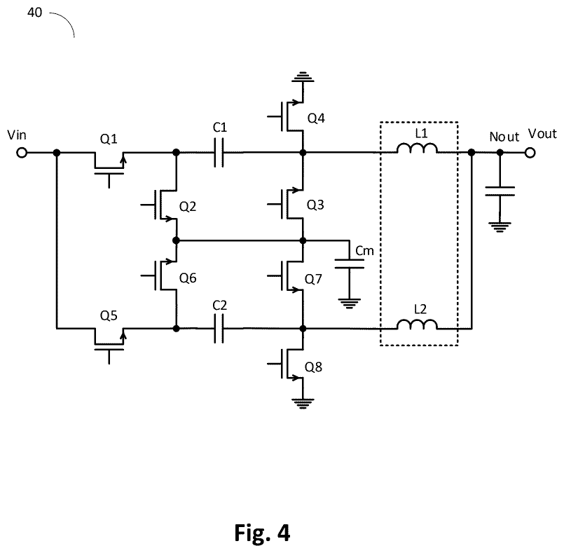

FIG. 4 is a schematic diagram illustrating a power conversion circuit having multiple hybrid switched-capacitor converters according to an embodiment of the present invention. The power conversion circuit 40 differs from the power conversion circuit 20 shown in FIG. 2 in that, in this embodiment, the output terminals of the two hybrid switched-capacitor converters are electrically connected together as a common output terminal Nout to output a common output voltage Vout.

In one embodiment of the power conversion circuit 40 shown in FIG. 4, the first inductor L1 and the second inductor L2 are magnetically coupled through a magnetic core.

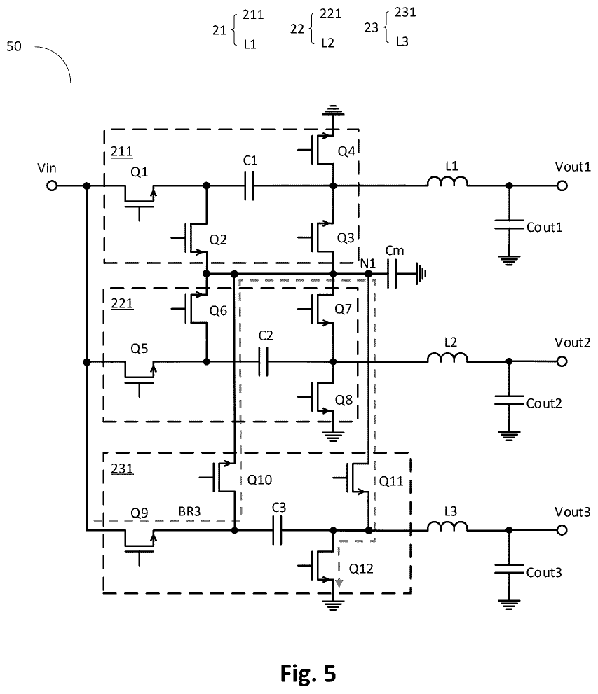

FIG. 5 is a schematic diagram illustrating a power conversion circuit having multiple hybrid switched-capacitor converters according to an embodiment of the present invention. The power conversion circuit 50 differs from the power conversion circuit 20 shown in FIG. 2 in that, in this embodiment, the power conversion circuit 50 further includes a third hybrid switched-capacitor converter 23.

The third hybrid switched-capacitor converter 23 includes a third switched-capacitor voltage divider circuit 231 and a third inductor L3 electrically coupled to each other. The third switched-capacitor voltage divider circuit 231 includes a ninth switch Q9, a tenth switch Q10, an eleventh switch Q11, a twelfth switch Q12, and a third flying capacitor C3. The switches Q9-Q12 are sequentially connected in order between the input voltage Vin and the ground potential. As shown in FIG. 5, the switches Q9-Q12 are serially connected in order to form a third branch BR3, as indicated by a dashed line with arrows in FIG. 5. Notably, in this embodiment, the first terminal N1 of the middle capacitor Cm is further connected to a node between the tenth switch Q10 and the eleventh switch Q11 of the third branch BR3, so as to cooperate with the third flying capacitor C3 to perform a switched-capacitor operation. At the output side, a third output capacitor Cout3 is coupled to the output of the third hybrid switched-capacitor converter 23 to stabilize the third output voltage Vout3. In other words, in this embodiment, the middle capacitor Cm is shared by the first hybrid switched-capacitor converter 21, the second hybrid switched-capacitor converter 22, and the third hybrid switched-capacitor converter 23 to jointly perform switched-capacitor operations with their respective flying capacitors.

This embodiment demonstrates that the power conversion circuit having multiple hybrid switched-capacitor converters of the present invention is not limited to two hybrid converters. In practical applications, the number of hybrid switched-capacitor converters can be increased to provide additional output voltages as required. For example, in this embodiment, the additional third hybrid switched-capacitor converter 23 generates a third output voltage Vout3. Through this scalable architecture, the invention can flexibly meet system requirements for multiple output voltages, making it suitable for complex load systems or applications requiring multiple voltage rails.

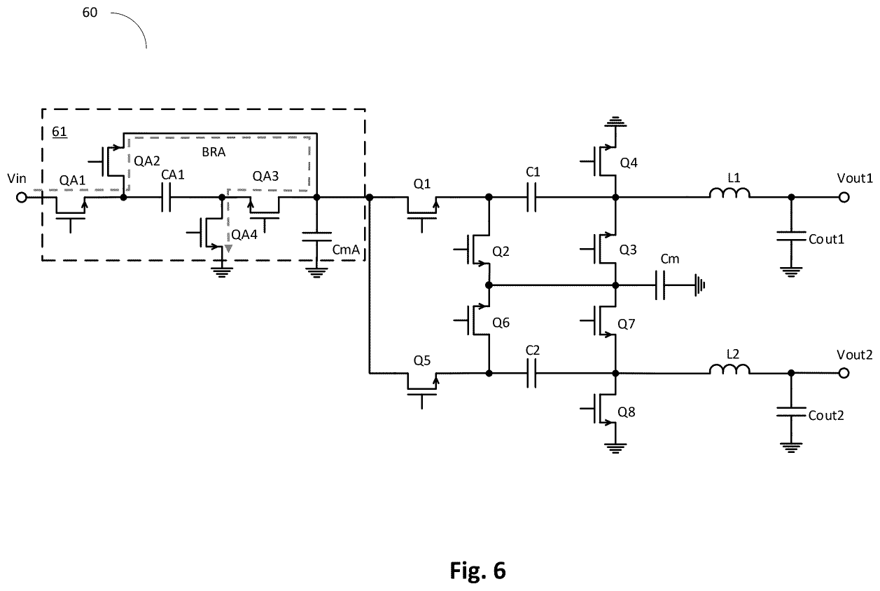

FIG. 6 is a schematic diagram illustrating a power conversion circuit having multiple hybrid switched-capacitor converters according to an embodiment of the present invention. The embodiment shown in FIG. 6 differs from that in FIG. 2 in that the power conversion circuit 60 further includes a pre-regulator 61. The pre-regulator 61 is implemented as a 2:1 switched-capacitor converter (hereinafter referred to as a “divided-by-two switched-capacitor converter”) and is coupled between the input voltage Vin and the first switch Q1 and fifth switch Q5. The pre-regulator 61 converts the input voltage Vin into a half-voltage (Vin/2) and couples it through an auxiliary middle capacitor CmA to the inputs of the first and second hybrid switched-capacitor converters 21 and 22. By means of the pre-regulator 61, the auxiliary middle capacitor CmA provides a voltage approximately equal to one-half of the input voltage Vin, thereby reducing the operating voltages of the flying capacitors C1 and C2 and the middle capacitor Cm to approximately one-quarter of the input voltage Vin.

As shown in FIG. 6, the pre-regulator 61 includes a first auxiliary switch QA1, a second auxiliary switch QA2, a third auxiliary switch QA3, a fourth auxiliary switch QA4, an auxiliary flying capacitor CA1, and an auxiliary middle capacitor CmA. The auxiliary switches QA1-QA4 are sequentially connected in order between the input voltage Vin and the ground potential, forming an auxiliary branch BRA, as indicated by a dashed line with arrows in FIG. 6. One end of the auxiliary flying capacitor CA1 is connected to a node between the first and second auxiliary switches QA1 and QA2, and the other end is connected to a node between the third and fourth auxiliary switches QA3 and QA4, such that the auxiliary flying capacitor CA1 is connected in parallel with the series-connected second and third auxiliary switches QA2 and QA3.

The embodiment shown in FIG. 6 is intended to demonstrate that, by employing this two-stage voltage division design, the voltage stresses of the capacitors and switches in the subsequent converter stages can be significantly reduced. As a result, the overall circuit can operate under higher input voltages (for example, 48 V) while still utilizing lower-voltage-rated components, thereby reducing cost, improving conversion efficiency, and enhancing reliability. Hence, the architecture of FIG. 6 is particularly suitable for high-efficiency power conversion applications that require high voltage conversion ratios.

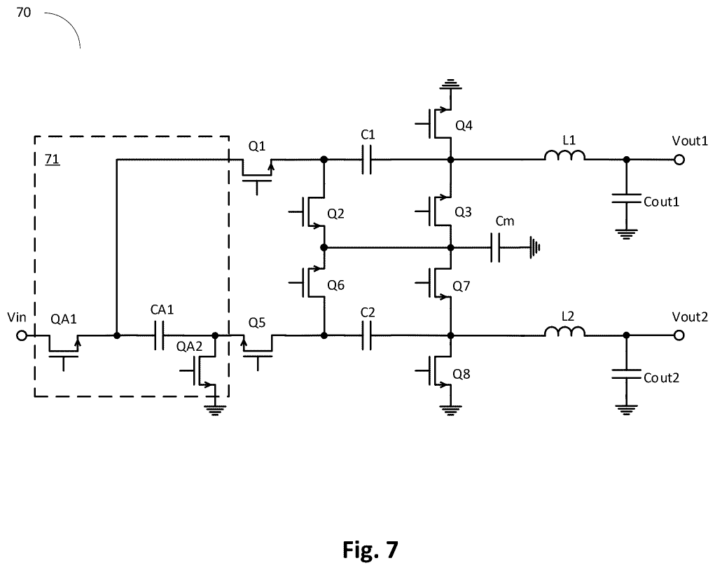

FIG. 7 is a schematic diagram illustrating a power conversion circuit having multiple hybrid switched-capacitor converters according to an embodiment of the present invention. The embodiment shown in FIG. 7 differs from FIG. 2 in that the power conversion circuit 70 further includes a pre-regulator 71. The pre-regulator 71 is implemented as a divided-by-two switched-capacitor converter and is coupled between the input voltage Vin and the first switch Q1 and the fifth switch Q5 to convert the input voltage Vin to a half input voltage Vin/2. By means of the pre-regulator 71, a voltage approximately equal to one-half of the input voltage Vin is obtained, thereby further reducing the operating voltages of the downstream flying capacitors C1 and C2 and the middle capacitor Cm to approximately one-quarter of the input voltage Vin.

As shown in FIG. 7, the pre-regulator 71 performs a switched-capacitor operation, and the pre-regulator 71 includes a first auxiliary switch QA1, a second auxiliary switch QA2, and an auxiliary flying capacitor CA1. Through the first auxiliary switch QA1, the second auxiliary switch QA2, and the auxiliary flying capacitor CA1, a two-phase voltage division of the input voltage Vin is achieved across different charge and discharge intervals so that the voltage drop of the input voltage Vin is distributed to the auxiliary flying capacitor CA1 in each phase. From one perspective, the pre-regulator 71 reuses the first switch Q1 and the fifth switch Q5 to accomplish the front-stage step-down operation. By way of example, when the first switch Q1 is turned ON, the second auxiliary switch QA2 is also turned ON so that the auxiliary flying capacitor CA1 is connected between the flying capacitor C1 and the ground potential; when the fifth switch Q5 is turned ON, the first auxiliary switch QA1 is also turned ON so that the auxiliary flying capacitor CA1 is electrically connected between the input voltage Vin and the flying capacitor C2.

The embodiment of FIG. 7 is intended to illustrate that, by adding the auxiliary flying capacitor CA1, the first auxiliary switch QA1, and the second auxiliary switch QA2, a higher voltage conversion ratio can be realized, thereby further reducing the voltage stress on the capacitors and switching devices in the circuit, improving overall efficiency, and increasing flexibility in component selection. Accordingly, this architecture is particularly suitable for higher input-voltage scenarios (for example, 48 V or higher) while maintaining characteristics of high efficiency, low cost, and high reliability.

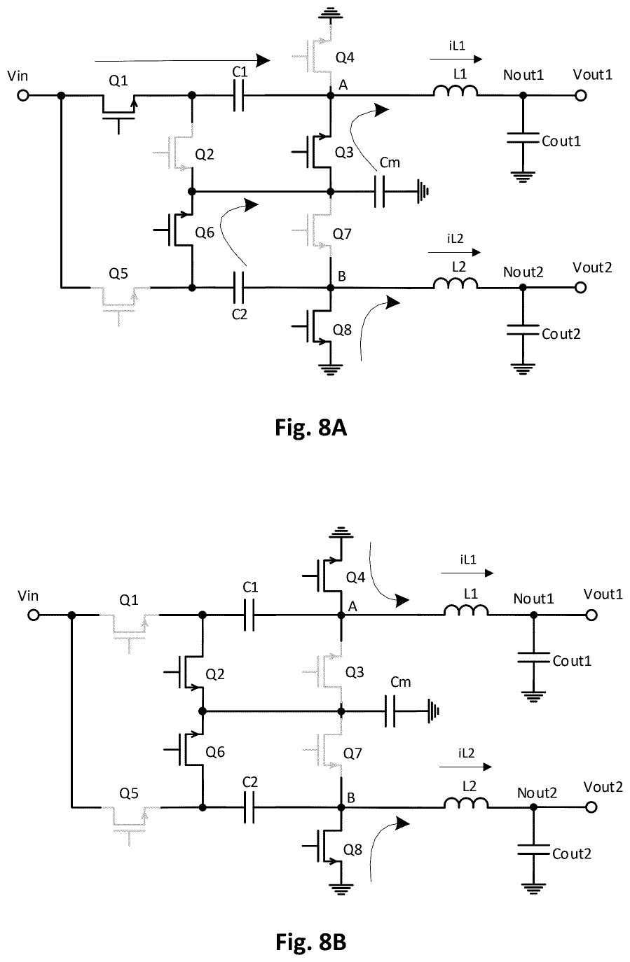

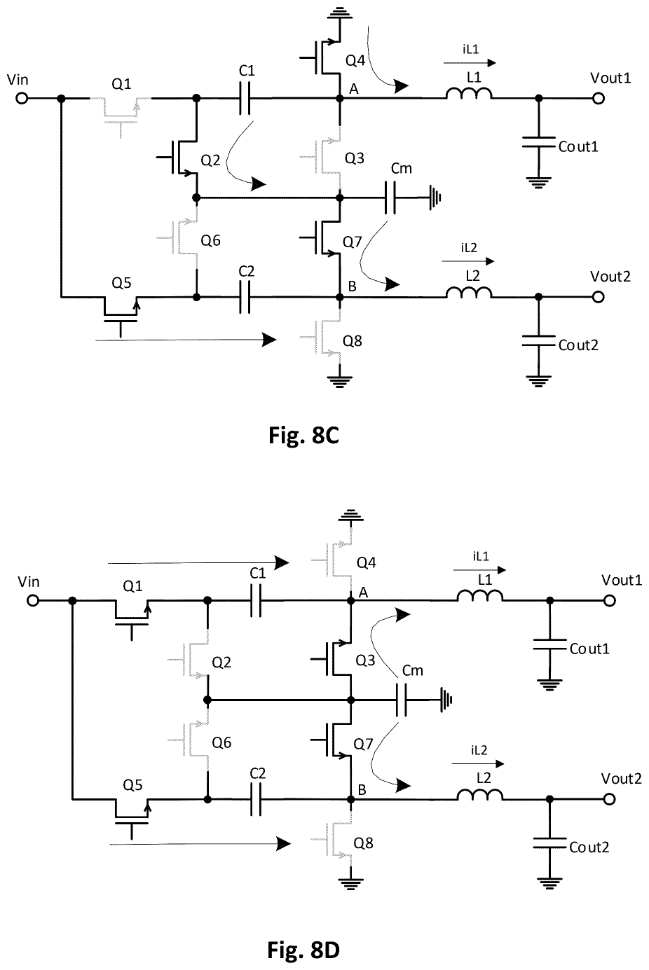

FIG. 8A-8D are schematic diagrams illustrating different switching states according to an embodiment of the present invention.

Using the power conversion circuit 20 of FIG. 2 as an example, the switched-capacitor operations within one switching period, the magnetizing and demagnetizing operations of the inductors, and the cooperation of the middle capacitor with the flying capacitors to perform switched-capacitor operations are described.

FIG. 8A illustrates the first switching state. In the first switching state, Q1, Q3, Q6, and Q8 are ON while Q2, Q4, Q5, and Q7 are OFF; thus, the flying capacitor C1 and the first inductor L1 are connected in series between the input voltage Vin and the first output voltage Vout1, C2 and Cm are connected in parallel to the node A, and the second inductor L2 is connected between the ground potential and the second output voltage Vout2. At this time L1 is magnetized under the voltage (VA−Vout1) to generate an inductor current iL1, and L2 releases energy through Q8 to Nout2 and is demagnetized to generate an inductor current iL2. In this first switching state, C1 is charging, and C2 and Cm are discharging. Here, the voltage VA denotes the voltage at node A and, in steady state, during the first switching state VA is approximately Vin×½, i.e., Vin minus the DC bias of C1 which is also approximately Vin×½.

In the first switching state of FIG. 8A, L1 performs magnetization and L2 performs demagnetization. The capacitor C1 is charged from the input voltage Vin through Q1 (by the switched-capacitor operation); the capacitor C2 through Q6 and Q3, and the middle capacitor Cm through Q3, release energy to node A to assist the magnetization of L1.

FIG. 8B illustrates the second switching state. In the second switching state, Q2, Q4, Q6, and Q8 are ON while Q1, Q3, Q5, and Q7 are OFF; thus, the first inductor L1 is electrically connected between the ground potential and the first output voltage Vout1, the second inductor L2 is electrically connected between the ground potential and the second output voltage Vout2, and C1, C2, and Cm are electrically connected in parallel. At this time L1 demagnetizes to Nout1 through Q4 to form the inductor current iL1; and L2 likewise demagnetizes to Nout2 through Q8 to form the inductor current iL2. In this stage, L1 and L2 demagnetize simultaneously. During this second stage, C1, C2, and Cm can exchange charge with one another but do not charge from or discharge to the input or output rails.

FIG. 8C illustrates the third switching state. In the third switching state, Q2, Q4, Q5, and Q7 are ON while Q1, Q3, Q6, and Q8 are OFF; thus, the flying capacitor C2 and the second inductor L2 are electrically connected in series between the input voltage Vin and the second output voltage Vout2, and C1 and Cm are electrically connected in parallel to the node B, and the first inductor L1 is connected between the ground potential and the first output voltage Vout1. At this time L1 demagnetizes to Nout1 through Q4 to generate the inductor current iL1, and L2 is magnetized under the voltage (VB−Vout2) to generate the inductor current iL2. In this stage, C2 is charging, while C1 and Cm are discharging. That is, in the third switching state, L1 demagnetizes and L2 magnetizes; C2 is charged from the input voltage Vin through Q5 by the switched-capacitor operation, and C1 through Q2 and Q7, as well as the middle capacitor Cm through Q7, release energy to node B to assist the magnetization of L2. Here, the voltage VB denotes the voltage at node B and, in steady state, during the third switching state, VB is approximately Vin×½, i.e., Vin minus the DC bias of C2 which is also approximately Vin×½.

FIG. 8D illustrates the fourth switching state. In the fourth switching state, Q1, Q3, Q5, and Q7 are ON while Q2, Q4, Q6, and Q8 are OFF; thus, C1 and the first inductor L1 are electrically connected in series between the input voltage Vin and the first output voltage Vout1, C2 and the second inductor L2 are electrically connected in series between the input voltage Vin and the second output voltage Vout2, and Cm is electrically connected in parallel to both node A and node B. At this time L1 is magnetized under the voltage (VA−Vout1) to generate the inductor current iL1, and L2 is magnetized under the voltage (VB−Vout2) to generate the inductor current iL2. Meanwhile, C1 is charged from the input voltage Vin through Q1, C2 is likewise charged from the input voltage Vin through Q5 by the switched-capacitor operation, and Cm discharges through Q3 and Q7 to supply energy to both inductors L1 and L2 to assist their magnetization.

By cyclically operating through the four switching states described above, the hybrid switched-capacitor converter of the present invention effectively reduces the voltage stress of the inductors and switching devices and, through the switched-capacitor operations of the flying capacitors and the middle capacitor, improves conversion efficiency to achieve high-efficiency and stable voltage conversion.

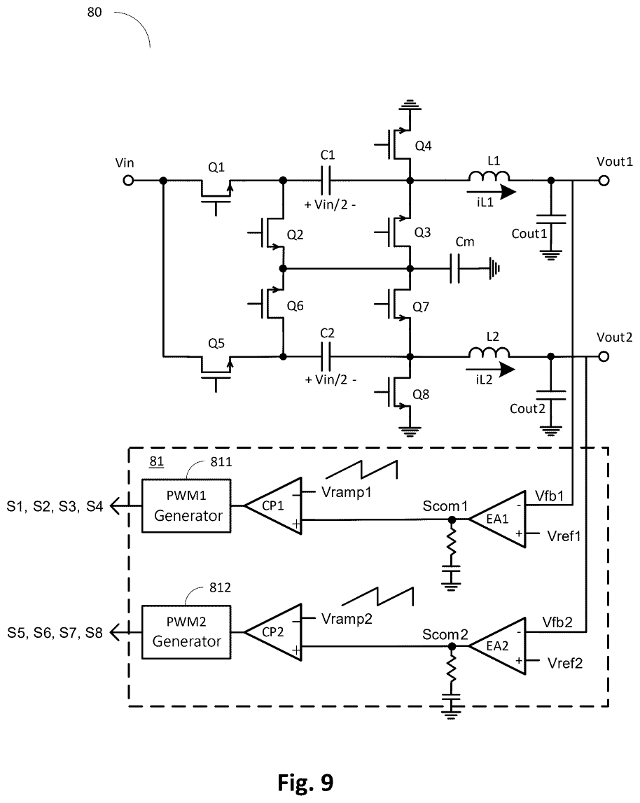

FIG. 9 is a schematic diagram illustrating a power conversion circuit having multiple hybrid switched-capacitor converters according to an embodiment of the present invention. The embodiment shown in FIG. 9 differs from that of FIG. 2 in that the power conversion circuit 80 further includes a control signal generation circuit 81. The control signal generation circuit 81, for example, includes a first error amplifier EA1, a second error amplifier EA2, a first comparator CP1, a second comparator CP2, a first PWM signal generator 811 (PWM1 generator), and a second PWM signal generator 812 (PWM2 generator).

The first error amplifier EA1 generates a first amplified signal Scom1 according to a difference between a first feedback voltage Vfb1 and a first reference voltage Vref1, where the first feedback voltage Vfb1 corresponds to the first output voltage Vout1. The second error amplifier EA2 generates a second amplified signal Scom2 according to a difference between a second feedback voltage Vfb2 and a second reference voltage Vref2, where the second feedback voltage Vfb2 corresponds to the second output voltage Vout2. Resistors and capacitors coupled to the first and second error amplifiers EA1 and EA2 provide frequency compensation to ensure loop stability and transient response. The PWM1 generator 811 generates switching control signals S1, S2, S3, and S4 according to a comparison between the first amplified signal Scom1 and a first ramp signal Vramp1. The PWM2 generator 812 generates switching control signals S5, S6, S7, and S8 according to a comparison between the second amplified signal Scom2 and a second ramp signal Vramp2.

The comparator CP1 determines a first duty ratio D1 according to the relationship between Scom1 and Vramp1, and the PWM1 generator 811 generates the switching control signals S1, S2, S3, and S4 accordingly. Similarly, the comparator CP2 determines a second duty ratio D2 according to the relationship between Scom2 and Vramp2, and the PWM2 generator 812 generates the switching control signals S5, S6, S7, and S8 accordingly. In this embodiment, the switching control signals S1, S2, S3, and S4 correspond to switches Q1, Q2, Q3, and Q4, respectively, while the switching control signals S5, S6, S7, and S8 correspond to switches Q5, Q6, Q7, and Q8, respectively.

A phase shift is introduced between Vramp1 and Vramp2 to control the phase relationship between the switching control signals S1 and S5. When the phase shift is 180 degrees, S1 and S5 operate in an interleaved and non-overlapping manner; when the phase shift is 0 degrees, S1 and S5 operate synchronously. The phase shift may also be set to other angles, such as 90 degrees or 270 degrees. The output voltages Vout1 and Vout2 can be adjusted by modifying the duty ratios of the switching control signals to satisfy relationships such as:

Vout1=Vin×D1/2, and Vout2=Vin×D2/2,

where D1, for example, is the duty ratio of S1 and S3, and D2 is the duty ratio of S5 and S7.

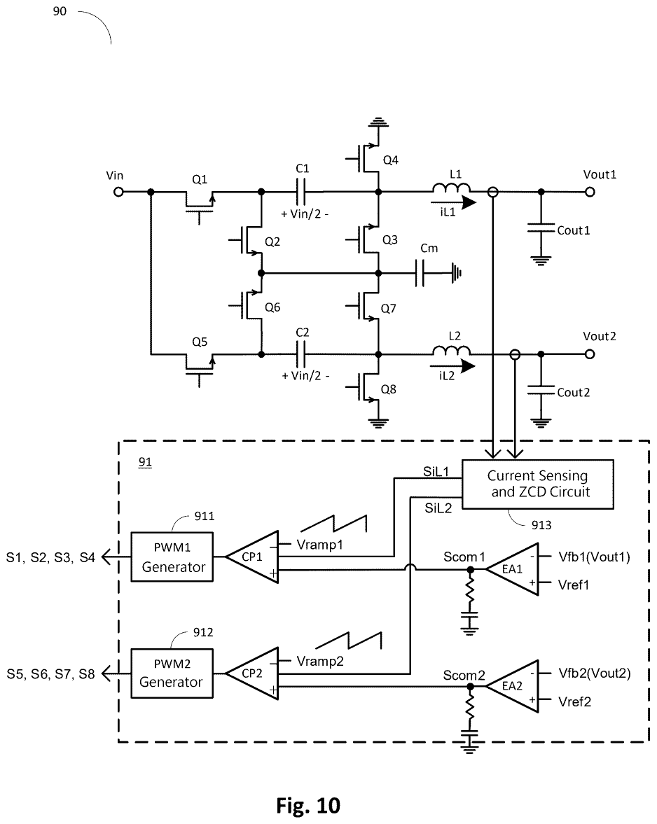

FIG. 10 is a schematic diagram illustrating a power conversion circuit having multiple hybrid switched-capacitor converters according to another embodiment of the present invention. The embodiment shown in FIG. 10 differs from that of FIG. 9 in that the power conversion circuit 90 further includes a control signal generation circuit 91 incorporating a current sensing and zero-current detection (ZCD) circuit 913. The current sensing and ZCD circuit 913 senses the inductor currents iL1 and iL2 to generate a first inductor current signal SiL1 and a second inductor current signal SiL2, respectively. The PWM1 generator 911 generates switching control signals S1, S2, S3, and S4 based on the superposition and comparison of the first inductor current signal SiL1, the first amplified signal Scom1, and the first ramp signal Vramp1. The PWM2 generator 912 generates switching control signals S5, S6, S7, and S8 based on the superposition and comparison of the second inductor current signal SiL2, the second amplified signal Scom2, and the second ramp signal Vramp2. This embodiment adopts a current-mode PWM control scheme. In addition, the inductor current signals SiL1 and SiL2 may include zero-current detection (ZCD) information for determining the end point of demagnetization.

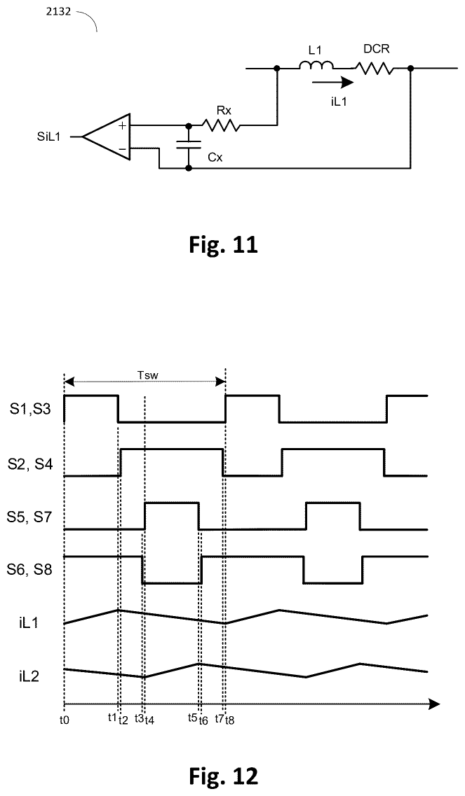

FIG. 11 is a schematic diagram illustrating a current sensing circuit of the control signal generation circuit according to an embodiment of the present invention. As shown in FIG. 11, the current sensing circuit 2132 includes a sensing resistor Rx and a sensing capacitor Cx. The sensing resistor Rx and sensing capacitor Cx are electrically connected in series and coupled to the first inductor L1. By detecting the voltage across the sensing capacitor Cx, the first inductor current iL1 is sensed to generate the first inductor current signal SiL1, wherein the time constant of the sensing resistor Rx and sensing capacitor Cx matches the time constant of the first inductor L1 and the DC resistance (DCR) of the first inductor L1.

FIG. 12 is a waveform diagram illustrating signals related to the power conversion circuit having multiple hybrid switched-capacitor converters according to an embodiment of the present invention. The horizontal axis represents time t, and the vertical axis represents the corresponding signal waveforms. The embodiment shown in FIG. 12 illustrates steady-state operation under switching conditions where the duty ratio is less than 50%, based on the embodiment shown in FIG. 2. One switching period Tsw, represented by time points t0 to t8, is used as an example. The switching period Tsw refers to a complete period in which all output switching operations and energy conversion processes of the power conversion circuit having multiple hybrid switched-capacitor converters are completed. The switching period Tsw continuously and periodically repeats during circuit operation.

During the time interval t0-t1, the circuit operates in the first switching state (as shown in FIG. 8A). During the time intervals t2-t3 and t6-t7, the circuit operates in the second switching state (as shown in FIG. 8B). During the time interval t4-t5, the circuit operates in the third switching state (as shown in FIG. 8C). The time intervals t1-t2, t3-t4, t5-t6, and t7-t8 represent dead-time periods for the switching control signals, during which all switches that are about to transition states are turned OFF. Therefore, within one switching period Tsw (i.e., between t0 and t8), the converter sequentially transitions through the following order of

states: (state 1→state 2→state 3→state 2).

In this embodiment, the switching control signals S1 and S5 operate in an interleaved manner with a phase shift of 180 degrees. This interleaved operation effectively reduces the input current ripple, thereby allowing the input capacitor's capacitance and physical size to be reduced.

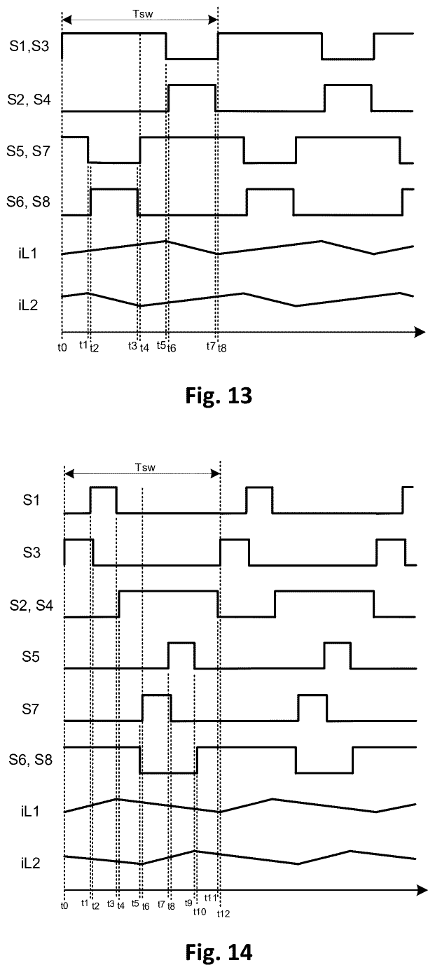

FIG. 13 is a waveform diagram illustrating signals related to the power conversion circuit having multiple hybrid switched-capacitor converters according to an embodiment of the present invention. The horizontal axis represents time t, and the vertical axis represents the corresponding signal waveforms. The embodiment shown in FIG. 13 is based on the power conversion circuit shown in FIG. 2, operating under steady-state conditions with a duty ratio greater than 50%. During the time intervals t0-t1 and t4-t5, the power conversion circuit having multiple hybrid switched-capacitor converters operates in the fourth switching state (as shown in FIG. 8D). During the time interval t2-t3, the circuit operates in the first switching state (as shown in FIG. 8A), and during the time interval t6-t7, the circuit operates in the third switching state (as shown in FIG. 8C). The time intervals t1-t2, t3-t4, t5-t6, and t7-t8 are dead-time intervals for the switching control signals. Accordingly, within one switching period Tsw, i.e., from t0 to t8, the converter sequentially operates through the following switching sequence: (state 4→state 1→state 4→state 3).

FIG. 14 is a waveform diagram illustrating signals related to the power conversion circuit having multiple hybrid switched-capacitor converters according to an embodiment of the present invention. The horizontal axis represents time t, and the vertical axis represents the corresponding signal waveforms. The embodiment shown in FIG. 14 is based on the power conversion circuit shown in FIG. 2, operating under steady-state conditions with a duty ratio lower than 50%. One switching period Tsw is illustrated by time points t0 to t12. The duty ratio of the switching control signals S1 and S3 is set to D1/2, and the duty ratio of the switching control signals S5 and S7 is set to D2/2.

During the time interval t0-t2, the third switch Q3 is turned

ON to magnetize the first inductor L1 and raise the voltage VA at switching node A to Vin/2 (refer to FIG. 8A-8D). Since the first flying capacitor C1 and the middle capacitor Cm both have a DC bias of Vin/2, when the first switch Q1 turns ON at time t1, the voltage across Q1 is nearly zero, achieving zero-voltage switching (ZVS) and thereby reducing switching loss. During the time interval t1-t3, the first switch Q1 remains ON to continue the magnetization of the first inductor L1. The ON periods of the switching control signals S1 and S3 preferably overlap, for example, during the time interval t1-t2. In one embodiment, the overlap may extend to time t3, meaning that the ON-time overlap of S1 and S3 may include the entire ON duration of S1 (from t1 to t3).

During the time intervals t4-t5 and t10-t11, the power conversion circuit having multiple hybrid switched-capacitor converters enters the second switching state (as shown in FIG. 8B).

During the time interval t6-t8, the seventh switch Q7 is turned ON to magnetize the second inductor L2 and raise the voltage VB at switching node B to Vin/2. Since the second flying capacitor C2 and the middle capacitor Cm also have a DC bias of Vin/2, when the fifth switch Q5 turns ON at time t7, the voltage across Q5 is nearly zero, achieving zero-voltage switching (ZVS) and thereby reducing switching loss. During the time interval t7-t9, the fifth switch Q5 remains ON to continue the magnetization of the second inductor L2. The ON periods of the switching control signals S5 and S7 may overlap during the time interval t9-t10. Similarly, in one embodiment, the overlap between the ON periods of S5 and S7 may include the entire ON duration of S5.

The time intervals t3-t4, t5-t6, t7-t8, and t11-t12 represent dead-time intervals for the switching control signals, during which the corresponding switches are maintained in the OFF state to ensure safe transition between switching states.

The present invention has been described in considerable detail with reference to certain preferred embodiments thereof. It should be understood that the description is for illustrative purpose, not for limiting the broadest scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, to perform an action “according to” a certain signal as described in the context of the present invention is not limited to performing an action strictly according to the signal itself, but can be performing an action according to a converted form or a scaled-up or down form of the signal, i.e., the signal can be processed by a voltage-to-current conversion, a current-to-voltage conversion, and/or a ratio conversion, etc. before an action is performed. It is not limited for each of the embodiments described hereinbefore to be used alone; under the spirit of the present invention, two or more of the embodiments described hereinbefore can be used in combination. For example, two or more of the embodiments can be configured together, or, a part of one embodiment can be configured to replace a corresponding part of another embodiment. In view of the foregoing, the spirit of the present invention should cover all such and other modifications and variations, which should be interpreted to fall within the scope of the following claims and their equivalents.

What is claimed is:

1. A power conversion circuit having multiple hybrid switched-capacitor converters, configured to convert an input voltage to a first output voltage at a first output terminal and a second output voltage at a second output terminal, comprising:
a first hybrid switched-capacitor converter comprising a first switched-capacitor voltage divider circuit and a first inductor electrically coupled to each other, wherein the first switched-capacitor voltage divider circuit comprises:
a first switch, a second switch, a third switch, and a fourth switch, electrically connected in order from the input voltage to a ground potential; and
a first flying capacitor, having an end electrically connected to a node between the first switch and the second switch, and another end electrically connected to a node between the third switch and the fourth switch;
wherein the first switched-capacitor voltage divider circuit is configured to perform a first switched-capacitor operation by controlling the first switch, the second switch, the third switch, and the fourth switch according to a first pulse-width modulation (PWM) signal group, such that the input voltage is converted to two voltage levels of a first voltage division group;
wherein a switching end of the first inductor is configured to switch between the two voltage levels of the first voltage division group according to the first PWM signal group, such that the first inductor is periodically magnetized and demagnetized to convert the input voltage to the first output voltage;
a second hybrid switched-capacitor converter comprising a second switched-capacitor voltage divider circuit and a second inductor electrically coupled to each other, wherein the second switched-capacitor voltage divider circuit comprises:
a fifth switch, a sixth switch, a seventh switch, and an eighth switch, electrically connected in order from the input voltage to the ground potential; and
a second flying capacitor, having an end electrically connected to a node between the fifth switch and the sixth switch, and another end electrically connected to a node between the seventh switch and the eighth switch;
wherein the second switched-capacitor voltage divider circuit is configured to perform a second switched-capacitor operation by controlling the fifth switch, the sixth switch, the seventh switch, and the eighth switch according to a second PWM signal group, such that the input voltage is converted into two voltage levels of a second voltage division group;
wherein a switching end of the second inductor is configured to switch between the two voltage levels of the second voltage division group according to the second PWM signal group, such that the second inductor is periodically magnetized and demagnetized to convert the input voltage to the second output voltage; and
a middle capacitor having a first terminal and a second terminal, wherein the first terminal is electrically connected to a node between the second switch and the third switch and also electrically connected to a node between the sixth switch and the seventh switch, and the second terminal is electrically connected to the ground potential,
wherein the middle capacitor is configured to cooperate with the first flying capacitor to perform the first switched-capacitor operation, and also to cooperate with the second flying capacitor to perform the second switched-capacitor operation.

2. The power conversion circuit having multiple hybrid switched-capacitor converters of claim 1, wherein the switching end of the first inductor is selectively electrically connected to a node between the first switch and the second switch, or to a node between the third switch and the fourth switch, and an output end of the first inductor is electrically coupled to the first output terminal; wherein the switching end of the second inductor is selectively electrically connected to a node between the fifth switch and the sixth switch, or to a node between the seventh switch and the eighth switch, and an output end of the second inductor is electrically connected to the second output terminal.

3. The power conversion circuit having multiple hybrid switched-capacitor converters of claim 1, wherein the first switch and the fifth switch are interleaved with a phase shift, the phase shift being 90 degrees, 180 degrees, or 270 degrees.

4. The power conversion circuit having multiple hybrid switched-capacitor converters of claim 1, wherein a frequency of the first PWM signal group is identical to a frequency of the second PWM signal group.

5. The power conversion circuit having multiple hybrid switched-capacitor converters of claim 1, wherein each of a voltage across the middle capacitor, a voltage across the first flying capacitor, and a voltage across the second flying capacitor has a DC bias of one-half or less of the input voltage.

6. The power conversion circuit having multiple hybrid switched-capacitor converters of claim 1, wherein when the first output voltage or the second output voltage is set higher than one-fourth of the input voltage, or in response to transient load variation, duty ratios of the first PWM signal group and the second PWM signal group are greater than 50%.

7. The power conversion circuit having multiple hybrid switched-capacitor converters of claim 1, wherein the first output terminal and the second output terminal are electrically connected as a common output terminal to provide a shared output voltage.

8. The power conversion circuit having multiple hybrid switched-capacitor converters of claim 7, wherein the first inductor and the second inductor are magnetically coupled through a magnetic material.

9. The power conversion circuit having multiple hybrid switched-capacitor converters of claim 1, further comprising a pre-regulator configured as a divided-by-two switched-capacitor converter and coupled between the input voltage and the first and fifth switches, for converting the input voltage to one-half of the input voltage.

10. The power conversion circuit having multiple hybrid switched-capacitor converters of claim 9, wherein the pre-regulator comprises an auxiliary flying capacitor, a first auxiliary switch, and a second auxiliary switch coupled between the input voltage, the first switch, and the fifth switch to perform a switched-capacitor operation.

11. A control method of a power conversion circuit having multiple hybrid switched-capacitor converters, wherein the power conversion circuit comprises a first hybrid switched-capacitor converter, a second hybrid switched-capacitor converter, and a middle capacitor electrically coupled to each other, the control method comprising:
controlling multiple switches of the first hybrid switched-capacitor converter according to a first PWM signal group to perform a first switched-capacitor operation and convert an input voltage into two voltage levels of a first voltage division group;
periodically switching a first inductor of the first hybrid switched-capacitor converter between the two voltage levels of the first voltage division group to perform magnetizing and demagnetizing operations, thereby converting the input voltage to a first output voltage at a first output terminal;
controlling multiple switches of the second hybrid switched-capacitor converter according to a second PWM signal group to perform a second switched-capacitor operation and convert the input voltage into two voltage levels of a second voltage division group;
periodically switching a second inductor of the second hybrid switched-capacitor converter between the two voltage levels of the second voltage division group to perform magnetizing and demagnetizing operations, thereby converting the input voltage to a second output voltage at a second output terminal; and
operating the middle capacitor to cooperate with a first flying capacitor of the first hybrid switched-capacitor converter to perform the first switched-capacitor operation, and to cooperate with a second flying capacitor of the second hybrid switched-capacitor converter to perform the second switched-capacitor operation.

12. The control method of the power conversion circuit having multiple hybrid switched-capacitor converters of claim 11, wherein the two voltage levels of the first voltage division group are two different levels among the input voltage, one-half of the input voltage, and a ground potential;
and the two voltage levels of the second voltage division group are two different levels among the input voltage, one-half of the input voltage, and the ground potential.

13. The control method of the power conversion circuit having multiple hybrid switched-capacitor converters of claim 11, wherein the first PWM signal group comprises two signals having a phase difference of 180 degrees, the second PWM signal group also comprises two signals having a phase difference of 180 degrees, and the first PWM signal group and the second PWM signal group are interleaved with a phase shift of 90 degrees, 180 degrees, or 270 degrees.

14. The control method of the power conversion circuit having multiple hybrid switched-capacitor converters of claim 11, wherein a frequency of the first PWM signal group is identical to a frequency of the second PWM signal group.

15. The control method of the power conversion circuit having multiple hybrid switched-capacitor converters of claim 11, wherein each of a voltage across the middle capacitor, a voltage across the first flying capacitor of the first hybrid switched-capacitor converter, and a voltage across the second flying capacitor of the second hybrid switched-capacitor converter has a DC bias of one-half or less of the input voltage.

16. The control method of the power conversion circuit having multiple hybrid switched-capacitor converters of claim 11, wherein when the first output voltage or the second output voltage is set higher than one-fourth of the input voltage, or in response to transient load variation, a duty ratio of the first PWM signal group or the second PWM signal group is greater than 50%.

17. The control method of the power conversion circuit having multiple hybrid switched-capacitor converters of claim 11, wherein the first output terminal and the second output terminal are electrically connected as a common output terminal to provide a shared output voltage.

18. The control method of the power conversion circuit having multiple hybrid switched-capacitor converters of claim 17, wherein the first inductor and the second inductor are magnetically coupled through a magnetic material.

19. The control method of the power conversion circuit having multiple hybrid switched-capacitor converters of claim 11, further comprising converting the input voltage to one-half of the input voltage, and then converting the one-half of the input voltage to two voltage levels of the first voltage division group and two voltage levels of the second voltage division group.
